(19) United States
(12) Patent Application Publication
(10) Pub. No.: US 2017/0242521 A1
(43) Pub. Date: Aug. 24, 2017

(54) TOUCH PANEL AND DRIVING METHOD THEREOF

(71) Applicant: Wuhan China Star Optoelectronics Technology Co., Ltd., Wuhan (CN)

(72) Inventors: Lulu XIE, Wuhan (CN); Ying-chi WANG, Wuhan (CN); Chun-hung HUANG, Wuhan (CN)

(21) Appl. No.: 15/161,348

(22) Filed: May 23, 2016

(30) Foreign Application Priority Data
Feb. 23, 2016 (CN) 201610097757.6

(51) Int. Cl. G06F 3/041; G06F 3/044

(52) U.S. Cl. CPC G06F 3/0416; G06F 3/044

(57) ABSTRACT

A touch panel having a plurality of electrode units, a touch display control circuit configured to apply voltage signals on the electrode units during a display driving period of the touch panel, and apply touch driving voltage signals on the electrode units during a touch driving period of the touch panel, wherein, a frame period including a plurality of unit frames of the touch panel, when the touch panel displays images of respective unit frames, the touch display control circuit applies touch driving voltage signals in different time on the electrode units during the touch driving period. A driving method of the touch panel is also disclosed. When the touch panel displays the images of respective unit frames, a position of a brightness anomaly on the image of each unit frame is not fixed by changing the time of applying the touch driving voltage signals applied on each electrode unit.

### CROSS-REFERENCE TO RELATED APPLICATIONS

This application claims priority to CN application 201610097757.6 filed on, Feb. 23, 2016, the disclosure of which is incorporated in its entirety by reference herein.

### TECHNICAL FIELD

The present invention belongs to a technical field of a touch display, in particularly, relates to a touch panel and a driving method thereof.

### BACKGROUND

A touch screen is an input apparatus to allow a user to use a finger or an object to input an instruction of the user by selecting instruction contents displayed on screens such as an image display and so on. The finger of the user or the object contacts the touch screen directly at a contact position. Since such touch screen can replace some independent input apparatuses such as a keyboard or a mouse etc. that are connected to the image display, the application field thereof has been enlarged day by day.

At present, according to composition structures, the touch screen may be classified into: an Add on Mode Touch Panel and an In-Cell Touch Panel. Wherein, the Add on Mode Touch Panel is formed by separately manufacturing a touch screen from a Liquid Crystal Display (LCD), and then attaching them together to form a liquid crystal display having a touch function, there are defects of a higher manufacturing cost, a lower light transmission, a thicker module and the like. However, the In-Cell Touch Panel is formed by embedding a touch control electrode of a touch screen in a liquid crystal display, thereby reducing a whole thickness, and greatly lowering cost of preparing the touch screen, and thus, such touch screen is preferred by most panel manufacturers.

At present, the existing In-Cell Touch Panel detects a touch position using a principle of mutual capacitance or self capacitance. Take the In-Cell Touch Panel using the principle of self capacitance as an example, the commonly used method is forming a plurality of independently common electrodes. During a display driving period, these common electrodes are applied on common voltage signals for image displaying, thereby being used as general common electrodes; during a touch driving period, these common electrodes are applied on touch driving voltage signals for touch driving, thereby being used as touch inductive electrodes. However, during the display driving period, the common voltage signals are direct current (DC) voltage signals, while during the touch driving period, the touch driving voltage signals are alternating current (AC) voltage signals, and thus, in a process of switching two kinds of voltage signals (especially at the switching moment), a temporary anomaly of a signal may be caused due to effects such as a signal delay etc., thereby causing various display problems of the In-Cell Touch Panel, for example, a display brightness of a fixed area of the In-Cell Touch Panel is different from a display brightness of other area thereof.

### SUMMARY

In order to solve the problem existing in the prior art, a purpose of the present invention is to provide a touch panel which includes: a plurality of electrode units; and a touch display control circuit configured to apply common voltage signals for image displaying on the electrode units during a display driving period of the touch panel, and configured to apply touch driving voltage signals for touch driving on the electrode units during a touch driving period of the touch panel, wherein, in a frame period including a plurality of unit frames of the touch panel, when the touch panel displays images of respective unit frames, the touch display control circuit is further configured to apply touch driving voltage signals in different time on the electrode units during the touch driving period of the touch panel.

Another purpose of the present invention is also to provide a driving method of a touch panel, and the touch panel includes a plurality of electrode units and a touch display control circuit, wherein the driving method of the touch panel comprising: applying, by the touch display control circuit, common voltage signals for image displaying on the electrode units during a display driving period of the touch panel; applying, by the touch display control circuit, touch driving voltage signals for touch driving on the electrode units during a touch driving period of the touch panel; wherein, in a frame period including a plurality of unit frames of the touch panel, when the touch panel displays images of respective unit frames, the touch display control circuit is further configured to apply touch driving voltage signals in different time on the electrode units during the touch driving period of the touch panel.

Furthermore, in the frame period of the touch panel, a time of applying the touch driving voltage signals when the touch panel displays an image of a current unit frame is ahead of a time of applying the touch driving voltage signals when the touch panel displays an image of a previous unit frame.

Furthermore, the touch driving voltage signals each includes a plurality of wave periods; wherein, in the frame period of the touch panel, the time of applying the touch driving voltage signals when the touch panel displays the image of the current unit frame is ahead of the time of applying the touch driving voltage signals for a wave period when the touch panel displays the image of the previous unit frame image.

Furthermore, in the frame period of the touch panel, a time of applying the touch driving voltage signals when the touch panel displays an image of a current unit frame is behind a time of applying the touch driving voltage signals when the touch panel displays an image of a previous unit frame.

Furthermore, the touch driving voltage signals each includes a plurality of wave periods; wherein, in the frame period of the touch panel, the time of applying the touch driving voltage signals when the touch panel displays the image of the current unit frame is behind of the time of applying the touch driving voltage signals for a wave period when the touch panel displays the image of the previous unit frame.

Advantageous effects of the present disclosure are as follows: When the touch panel of the present invention displays the images of respective unit frames, a position of a brightness anomaly on the image of each unit frame is not fixed by changing the time of applying the touch driving voltage signals applied on each electrode unit by the touch display control circuit, and scattering the position where the brightness anomaly of the image of each unit frame appears. Since human eyes have a persistence of vision, after the images are overlapped, the human eyes cannot feel the brightness anomaly of the images.

### BRIEF DESCRIPTION OF THE DRAWINGS

These and/or other aspects, characteristics and advantages of the embodiments of the invention will become apparent and more readily appreciated from the following description, taken in conjunction with the accompanying drawings in which:

FIG. 1 is a structure schematic view of a touch panel according to an embodiment of the present invention;

FIG. 2 is a wave diagram of a driving signal of a touch panel according to an embodiment of the present invention; and

FIG. 3 is a wave diagram of a driving signal of a touch panel according to another embodiment of the present invention.

### DETAILED DESCRIPTION

Embodiments of the present invention will be described in detail below by referring to the accompany drawings. However, the present invention can be implemented in numerous different forms, and the present invention should not be construed as being limited to the particular embodiments set forth herein. Instead, these embodiments are provided for explaining the principle and actual application of the present invention, thus other skilled in the art can understand various embodiments and amendments which are suitable for specific intended applications of the present invention.

In the drawings, for clarity, the thicknesses of a layer and an area are exaggerated. Like reference numerals can be used to denote like elements throughout the specification and drawings.

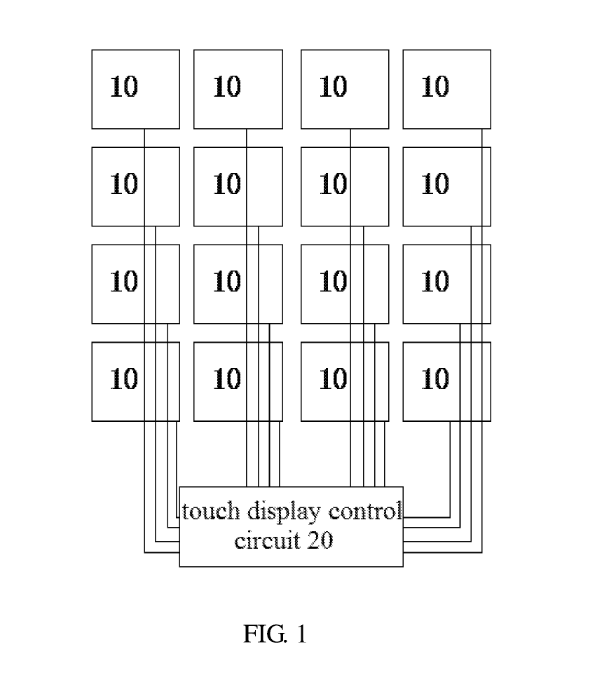

FIG. 1 is a structure schematic view of a touch panel according to an embodiment of the present invention.

Referring to FIG. 1, the touch panel according to the embodiment of the present invention includes: a plurality of electrode units 10 and a touch display control circuit 20 configured to provide voltage signals to the electrode units 10. It should be understood that, the touch panel according to the embodiment of the present invention can also include other necessary components.

In the embodiment, a display refresh frequency of the touch panel is 40 Hz, that is to say, the touch panel displays forty unit frame images in one second, and a display of a image of each unit frame needs 0.025 seconds. However, the present invention is not limited to the above, and the display refresh frequency of the touch panel can be set according to the practical requirement.

In the present embodiment, preferably, a plurality of electrode units 10 is arranged in an array. However, the present invention is not limited to the above, for example, a portion of the electrode units 10 extends in a first direction (e.g., a row direction), and the rest portion of the electrode units 10 extends in a second direction (e.g., a column direction); wherein the portion of the electrode units 10 and the rest portion thereof are disposed in an overlapped manner, and insulating layers (not shown) are disposed between the portion of the electrode units 10 and the rest portion thereof.

The electrode units 10 are made of transparent conductive materials, but the present invention is not limited to here; for example, the electrode units 10 are made of indium tin oxide (ITO).

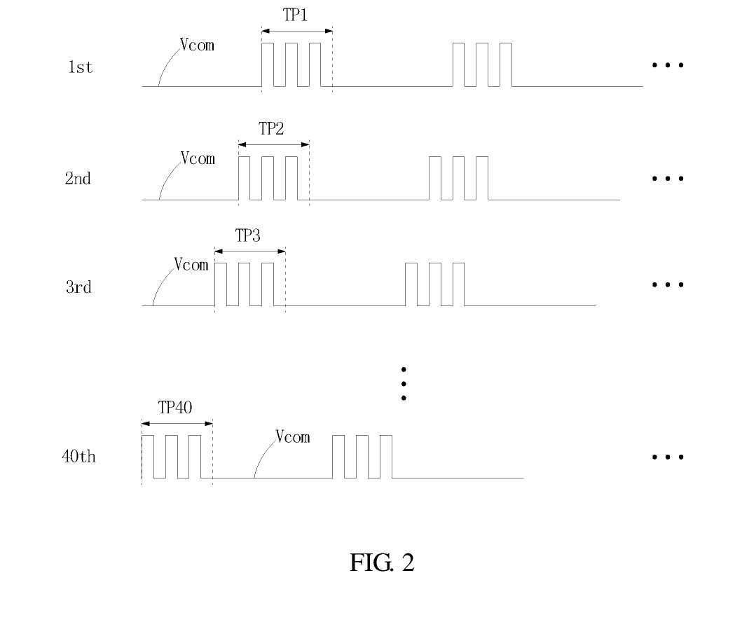

FIG. 2 is a wave diagram of a driving signal of a touch panel according to an embodiment of the present invention.

Referring to FIGS. 1 and 2, the forty images of unit frames displayed on the touch panel are set to be a frame period of the touch panel. Of course, it should be understood that, a number of unit frames included in a frame period of the touch panel is not limited to forty, the number of the unit frames included in a frame period of the touch panel can be set according to the practical requirement.

When the touch panel displays images of respective unit frames, the voltage signals provided to each electrode unit 10 by the touch display control circuit 20 include a common voltage signal Vcom and touch driving voltage signals TP1, TP2, TP3, . . . , TP40. The respective touch driving voltage signals TP1, TP2, TP3, . . . , TP40 include the same wave periods; wherein, each wave period is composed by a high level signal and a low level signal. Here, a time period for providing the common voltage signal Vcom is set as the display driving period of the touch panel, and a time period for providing the touch driving voltage signals TP1, TP2, TP3, . . . , TP40 is set as the touch driving period of the touch panel.

Hence, during the display driving period of the touch panel, a touch display control circuit 20 applies a common voltage signal Vcom for image displaying on each electrode unit 10; during the touch driving period of the touch panel, the touch display control circuit 20 applies the touch driving voltage signals TP1, TP2, TP3, . . . , TP40 for touch driving on the each electrode unit 10; wherein, in the frame period of the touch panel, when the touch panel displays the images of respective unit frames, the touch display control circuit 20 applies the touch driving voltage signals TP1, TP2, TP3, . . . , TP40 in different time on each electrode unit 10.

For example, referring to FIGS. 1 and 2 again, firstly, when the touch panel displays an image 1st of a first unit frame, during the display driving period of the touch panel, the touch display control circuit 20 applies the common voltage signal Vcom for image displaying on each electrode unit 10; during the touch driving period of the touch panel, the touch display control circuit 20 applies the touch driving voltage signal TP1 for touch driving on the each electrode unit 10.

Next, when the touch panel displays an image 2nd of a second unit frame, during the display driving period of the touch panel, the touch display control circuit 20 applies the common voltage signal Vcom for image displaying on each electrode unit 10; during the touch driving period of the touch panel, the touch display control circuit 20 applies the touch driving voltage signal TP2 for touch driving on the each electrode unit 10. Here, a time that the touch display control circuit 20 applies the touch driving voltage signal TP2 on each electrode unit 10 is ahead of a time that the touch display control circuit 20 applies the touch driving voltage signal TP1 on the each electrode unit 10. Preferably, the time that the touch display control circuit 20 applies the touch driving voltage signal TP2 on each electrode unit 10 is ahead of the time that the touch display control circuit 20 applies the touch driving voltage signal TP1 for a wave period on the each electrode unit 10.

Next, when the touch panel displays an image 3rd of a third unit frame, during the display driving period of the touch panel, the touch display control circuit 20 applies the common voltage signal Vcom for image displaying on each electrode unit 10; during the touch driving period of the touch panel, the touch display control circuit 20 applies the touch driving voltage signal TP3 for touch driving on the each electrode unit 10. Here, a time that the touch display control circuit 20 applies the touch driving voltage signal TP3 on each electrode unit 10 is ahead of the time that the touch display control circuit 20 applies the touch driving voltage signal TP2 on the each electrode unit 10. Preferably, the time that the touch display control circuit 20 applies the touch driving voltage signal TP3 on each electrode unit 10 is ahead of the time that the touch display control circuit 20 applies the touch driving voltage signal TP2 for a wave period on the each electrode unit 10.

And so forth.

Finally, when the touch panel displays an image 40th of a fortieth unit frame, during the display driving period of the touch panel, the touch display control circuit 20 applies the common voltage signal Vcom for image displaying on each electrode unit 10; during the touch driving period of the touch panel, the touch display control circuit 20 applies the touch driving voltage signal TP40 for touch driving on the each electrode unit 10. Here, a time that the touch display control circuit 20 applies the touch driving voltage signal TP40 on each electrode unit 10 is ahead of a time that the touch display control circuit 20 applies the touch driving voltage signal TP39 on the each electrode unit 10. Preferably, the time that the touch display control circuit 20 applies the touch driving voltage signal TP40 on each electrode unit 10 is ahead of the time that the touch display control circuit 20 applies the touch driving voltage signal TP39 for a wave period on the each electrode unit 10.

As described above, when the touch panel of the present invention displays the images of respective unit frames, a position of a brightness anomaly on the image of each unit frame is not fixed by changing the time of applying the touch driving voltage signals TP1, TP2, TP3, . . . , TP40 applied on each electrode unit 10 by the touch display control circuit 20, and scattering the position where the brightness anomaly of the image of each unit frame appears. Since human eyes have a persistence of vision, after the images are overlapped, the human eyes cannot feel the brightness anomaly of the images.

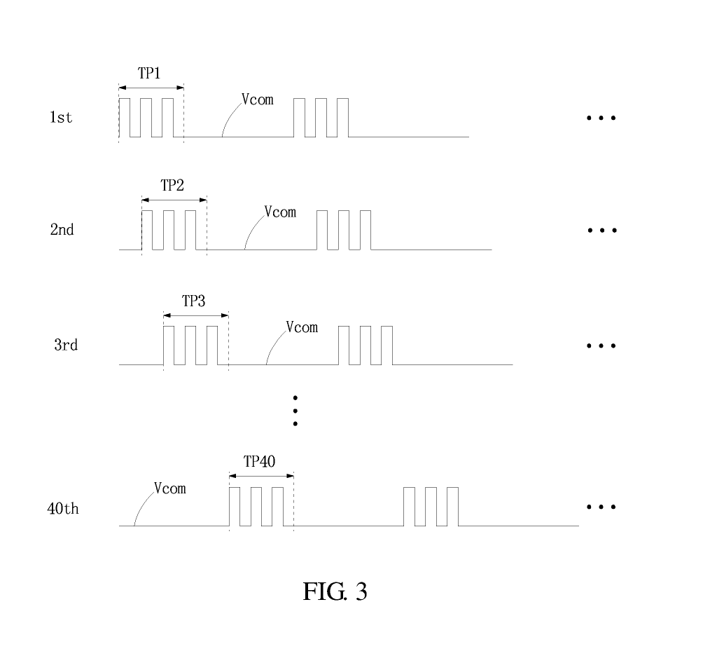

FIG. 3 is a wave diagram of a driving signal of a touch panel according to another embodiment of the present invention.

Referring to FIGS. 1 and 3, it is different from the above embodiment that, firstly, when the touch panel displays an image 1st of a first unit frame, during the display driving period of the touch panel, the touch display control circuit 20 applies the common voltage signal Vcom for image displaying on each electrode unit 10; during the touch driving period of the touch panel, the touch display control circuit 20 applies the touch driving voltage signal TP1 for touch driving on the each electrode unit 10.

Next, when the touch panel displays an image 2nd of a second unit frame, during the display driving period of the touch panel, the touch display control circuit 20 applies the common voltage signal Vcom for image displaying on each electrode unit 10; during the touch driving period of the touch panel, the touch display control circuit 20 applies the touch driving voltage signal TP2 for touch driving on the each electrode unit 10. Here, a time that the touch display control circuit 20 applies the touch driving voltage signal TP2 on each electrode unit 10 is behind a time that the touch display control circuit 20 applies the touch driving voltage signal TP1 on the each electrode unit 10. Preferably, the time that the touch display control circuit 20 applies the touch driving voltage signal TP2 on each electrode unit 10 is behind a time that the touch display control circuit 20 applies the touch driving voltage signal TP1 for a wave period on the each electrode unit 10.

Next, when the touch panel displays an image 3rd of a third unit frame, during the display driving period of the touch panel, the touch display control circuit 20 applies the common voltage signal Vcom for image displaying on each electrode unit 10; during the touch driving period of the touch panel, the touch display control circuit 20 applies the touch driving voltage signal TP3 for touch driving on the each electrode unit 10. Here, a time that the touch display control circuit 20 applies the touch driving voltage signal TP3 on each electrode unit 10 is behind a time that the touch display control circuit 20 applies the touch driving voltage signal TP2 on the each electrode unit 10. Preferably, the time that the touch display control circuit 20 applies the touch driving voltage signal TP3 on each electrode unit 10 is behind the time that the touch display control circuit 20 applies the touch driving voltage signal TP2 for a wave period on the each electrode unit 10.

And so forth.

Finally, when the touch panel displays an image 40th of a fortieth unit frame, during the display driving period of the touch panel, the touch display control circuit 20 applies the common voltage signal Vcom for image displaying on each electrode unit 10; during the touch driving period of the touch panel, the touch display control circuit 20 applies the touch driving voltage signal TP40 for touch driving on the each electrode unit 10. Here, a time that the touch display control circuit 20 applies the touch driving voltage signal TP40 on each electrode unit 10 is behind a time that the touch display control circuit 20 applies the touch driving voltage signal TP39 on the each electrode unit 10. Preferably, the time that the touch display control circuit 20 applies the touch driving voltage signal TP40 on each electrode unit 10 is behind the time that the touch display control circuit 20 applies the touch driving voltage signal TP39 for a wave period on the each electrode unit 10.

Although the present invention is described with reference to the special embodiments, those skilled in the art will understand: various changes in form and details may be made therein without departing from the spirit and scope of the invention as defined by the appended claims and its equivalents.

What is claimed is:

1. A touch panel, comprising:
a plurality of electrode units; and
a touch display control circuit configured to apply common voltage signals for image displaying on the electrode units during a display driving period of the touch panel, and configured to apply touch driving voltage signals for touch driving on the electrode units during a touch driving period of the touch panel,
wherein, in a frame period including a plurality of unit frames of the touch panel, when the touch panel displays images of respective unit frames, the touch display control circuit is further configured to apply touch driving voltage signals in different time on the electrode units during the touch driving period of the touch panel.

2. The touch panel of claim 1, wherein in the frame period of the touch panel, a time of applying the touch driving voltage signals when the touch panel displays an image of a current unit frame is ahead of a time of applying the touch driving voltage signals when the touch panel displays an image of a previous unit frame.

3. The touch panel of claim 2, wherein the touch driving voltage signals each including a plurality of wave periods, wherein, in the frame period of the touch panel, the time of applying the touch driving voltage signals when the touch panel displays the image of the current unit frame is ahead of the time of applying the touch driving voltage signals for a wave period when the touch panel displays the image of the previous unit frame.

4. The touch panel of claim 1, wherein in the frame period of the touch panel, a time of applying the touch driving voltage signals when the touch panel displays an image of a current unit frame is behind a time of applying the touch driving voltage signals when the touch panel displays an image of a previous unit frame.

5. The touch panel of claim 4, wherein the touch driving voltage signals each including a plurality of wave periods, wherein, in the frame period of the touch panel, the time of applying the touch driving voltage signals when the touch panel displays the image of the current unit frame is behind of the time of applying the touch driving voltage signals for a wave period when the touch panel displays the image of the previous unit frame.

6. A driving method of a touch panel, the touch panel comprising a plurality of electrode units and a touch display control circuit, wherein the driving method of the touch panel comprising:
applying, by the touch display control circuit, common voltage signals for image displaying on the electrode units during a display driving period of the touch panel; and
applying, by the touch display control circuit, touch driving voltage signals for touch driving on the electrode units during a touch driving period of the touch panel;
wherein, in a frame period including a plurality of unit frames of the touch panel, when the touch panel displays images of respective unit frames, applying, by the touch display control circuit, touch driving voltage signals in different time on the electrode units during the touch driving period of the touch panel.

7. The driving method of the touch panel of claim 6, wherein in the frame period of the touch panel, a time of applying the touch driving voltage signals when the touch panel displays an image of a current unit frame is ahead of a time of applying the touch driving voltage signals when the touch panel displays an image of a previous unit frame.

8. The driving method of the touch panel of claim 7, wherein the touch driving voltage signals each including a plurality of wave periods, wherein, in the frame period of the touch panel, the time of applying the touch driving voltage signals when the touch panel displays the image of the current unit frame is ahead of the time of applying the touch driving voltage signals for a wave period when the touch panel displays the image of the previous unit frame.

9. The driving method of the touch panel of claim 6, wherein in the frame period of the touch panel, a time of applying the touch driving voltage signals when the touch panel displays an image of a current unit frame is behind a time of applying the touch driving voltage signals when the touch panel displays an image of a previous unit frame.

10. The driving method of the touch panel of claim 9, wherein the touch driving voltage signals each including a plurality of wave periods, wherein, in the frame period of the touch panel, the time of applying the touch driving voltage signals when the touch panel displays the image of the current unit frame is behind of the time of applying the touch driving voltage signals for a wave period when the touch panel displays the image of the previous unit frame.
